(19) United States
(12) Patent Application Publication
(10) Pub. No.: US 2014/0266588 A1
(43) Pub. Date: Sep. 18, 2014

(54) PEER-TO-PEER BIKE SHARING SYSTEM

(71) Applicant: Mesh Motion, Inc., Kensington, CA (US)

(72) Inventor: Mehrdad MAJZOOBI, Kensington, CA (US)

(73) Assignee: Mesh Motion, Inc., Kensington, CA (US)

(21) Appl. No.: 14/217,027

(22) Filed: Mar. 17, 2014

Related U.S. Application Data
(60) Provisional application No. 61/786,470, filed on Mar. 15, 2013.

(51) Int. Cl. E05B 47/00; G07C 9/00

(52) U.S. Cl. CPC E05B 47/0012; G07C 9/00896
USPC 340/5.61; 70/18

(57) ABSTRACT

A battery-powered lock that is capable of communicating with a mobile device is described herein. A mobile device that is authorized to communicate with the lock can send lock and/or unlock commands to the lock. In addition, techniques are described for a station-less bike sharing system using the lock that enables a user to drop off and secure the rented bike anywhere at the end of the trip. Using the integrated GPS on the mobile device, the geographic location of the lock as well as the attached bike is tracked upon any lock/unlock requests. The mobile device communicates with an administration server to determine if a user is authorized to unlock the lock and utilize the bike.

### CROSS-REFERENCE TO RELATED APPLICATIONS

The present application claims priority to Provisional Application No. 61/786,470, entitled “Peer-to-Peer Sharing System,” filed Mar. 15, 2013, which is assigned to the Assignee hereof and expressly incorporated by reference herein in its entirety.

### TECHNICAL FIELD

The present disclosure relates generally to peer-to-peer object sharing, and in particular, to bike sharing and rental.

### BACKGROUND

With the high growth of urban population and the number of automobiles, cycling has become a popular mobility option for short distance urban travel. To discourage automobile dependence and encourage cycling, geographically dense communities such as cities and/or college campuses, have adopted bicycle sharing systems.

The bicycle sharing systems typically employ a locking station or rental kiosk. In these systems, credit card payments can be made through the rental kiosk based on the selected bicycle and rental duration. Solar panels is typically use to power these rental stations along with backup batteries to ensure reliability in case of power outage. In addition, bicycle stations must maintain a wireless communication link to an administration server to perform the payment transaction and remote monitoring. Such station-based bicycle rental systems require installation of expensive infrastructure, and incur high land acquisition costs as well as wireless data subscription fees.

The excessive cost and the amount of work and operation necessary to set up and start each station severely limit growth and prevent scalability of these systems. Moreover, users have to return the bicycles to specific locations/stations only.

Other alternative station-less bicycle rental systems typically employ a lock which includes a lock box and U-shaped retainer mounted and attached to each bicycle to secure the bicycle to any generic bicycle rack. The bicycles are equipped with a Global Positioning system (GPS) device for tracking. In addition, the bicycles include a solar panel or an internal dynamo hub (generator) along with a rechargeable battery to power the electronics and the lock. Each of the bicycles must maintain a constant wireless data connection over mobile communication network to the administration server.

Although such station-less bicycle sharing systems incur less setup and infrastructure installation costs, they yet require a separate GPS tracking device, battery, solar panel or internal hub dynamo for each bicycle. The mobile data connection also imposes recurring data subscription fees for each bicycle.

The present disclosure removes the aforementioned down-sides from bike sharing systems and dramatically reduces bike sharing implementation cost.

### SUMMARY

A lock according to one embodiment includes, in part, a shackle, a first housing, and a second housing that is positioned within the first housing. The shackle has a first and a second ends. The first housing has a first and a second side openings which are configured to receive the first and second ends of the shackle, respectively. The second housing includes, in part, a battery recess configured to receive a battery, a motor assembly, a locking cam, a motor control and a sensor. The motor assembly is positioned within a motor assembly recess of the second housing. The motor assembly includes a rotatable shaft that is drivable by the motor. The locking cam is coupled to the rotatable shaft and includes a first protuberance. The locking cam is rotatable between a locked position in which the first protuberance locks the first end within the first opening, and an unlocked position in which the first protuberance unlocks the first end within the first opening. The motor control circuitry is communicatively coupled to the motor. In one embodiment, the motor control circuitry includes a transceiver and a push button. The sensor (e.g., a Hall effect sensor) is positioned adjacent to the locking cam and is communicatively coupled to the motor control circuitry.

In one embodiment, the second housing further includes a removable, conductive battery cover. The battery cover electrically couples the battery and the motor control circuitry when the recess cover is removably attached to the second housing. In one embodiment, the first housing further includes one or more end openings configured to receive one or more end caps. In one embodiment, the lock further includes, a press-fit disc disposed within the first housing and between the locking cam and an end opening of the first housing. In one embodiment, the first end of the shackle includes a boss and the second end of the shackle is bent.

In one embodiment, the second housing further includes a second protuberance positioned on an exterior surface of the second housing. The second protuberance is configured to limit a range of rotation of the locking cam when the shaft is driven by the motor and a notch of the locking cam contacts the second protuberance. In one embodiment, the second housing is positioned between the first and the second side openings of the first housing.

A lock, according to one embodiment includes, in part, a shackle having first and second ends, a first housing and a second housing which is housed within the first housing. The first housing has first and second side openings which are configured to receive the first and second ends of the shackle, respectively. The second housing includes a battery, a motor assembly, a locking cam, a motor control circuitry and a sensor. The motor assembly includes a rotatable shaft drivable by a motor of the motor assembly. The locking cam is coupled to the rotatable shaft and includes a first protuberance. The locking cam is rotatable between a locked position where the first protuberance locks the first end within the first opening and an unlocked position where the first protuberance unlocks the first end within the first opening.

In one embodiment, the motor control circuitry is communicatively coupled to the motor. The motor control circuitry includes at least one of a transceiver and a push button. The push button is accessible via first and second button holes in the first and second housings, respectively. The sensor is positioned adjacent to the locking cam and is communicatively coupled to the motor control circuitry. The sensor is configured to determine whether the locking cam is in the locked position or the unlocked position. In one embodiment, upon receiving a user input at the motor control circuitry, the motor control circuitry instructs the motor to rotate the locking cam via the shaft to the locked position when the sensor determines that the locking cam is in the unlocked position. Similarly, the locking cam is rotated to the unlocked position when the sensor determines that the locking cam is in the locked position.

In one embodiment, the user input corresponds to at least one of a wireless communication received by the transceiver and a depression of the push button. In one embodiment, the motor includes a gearbox. In one embodiment, the motor control circuitry includes a microprocessor. In one embodiment, the transceiver is configured to exit a power sleep mode upon receiving an input. In one embodiment, the input corresponds to at least one of a depression of the push button and physically touching the lock.

Certain embodiments provide a method of sharing a bike. The method includes, in part, initializing a session on a lock in response to an input from a user. The lock being adapted to enable/disable operation of the bike when engaged with the bike. The method further includes, in part, causing a mobile device associated with the user to communicate with the lock in response to the initialization, accessing a server via the mobile device to verify if the mobile device is authorized to operate the lock, and causing the lock to open if the mobile device is authorized to operate the lock. When the lock is opened, the user is enabled to operate and ride the bike in accordance with a predefined agreement, such as a rental agreement.

In one embodiment, the mobile device communicates with the lock using a short-range wireless communication method. In one embodiment, the mobile device receives one or more parameters from the lock and transmits the one or more parameters to a server. The server verifies if the mobile device is authorized to operate the lock based at least on the one or more parameters. In one embodiment, the method further includes deactivating the lock if the session takes longer than a predefined time duration.

### BRIEF DESCRIPTION OF THE DRAWINGS

An understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an exemplary bike sharing system, in accordance with one embodiment.

FIG. 2 illustrates an example flow chart that may be employed by the lock to authenticate a mobile device, according to one embodiment.

FIG. 3 illustrates an exemplary logic flow chart employed by a mobile device to interact with the lock, according to one embodiment.

FIG. 4 illustrates a perspective view of an exemplary lock, according to one embodiment.

FIG. 5 illustrates a schematic exploded perspective view of the lock, according to one embodiment.

FIGS. 6A and 6B illustrate exemplary sectional views of the lock when the components are assembled inside the tube and the cam is in the unlocked position, according to one embodiment.

FIGS. 7A and 7B illustrate schematic sectional views of the lock when the components are assembled inside the tube and the cam is in the locked position, according to one embodiment.

FIG. 8 illustrates a schematic view of a housing that hosts the motor, gearbox, motor circuit controller, and the battery, according to one embodiment.

FIG. 9 illustrates the schematic perspective view of the back side of a cam, according to one embodiment.

FIG. 10 illustrates the schematic perspective view of the front side of the cam, according to one embodiment.

FIG. 11 illustrates a schematic perspective view of the housing and the cam in the locked position, according to one embodiment.

FIG. 12 illustrates a schematic perspective view of the housing and the cam in the unlocked position, according to one embodiment.

FIG. 13 illustrates a schematic perspective view of the cam in the locked position engaged with the cut away section at the end of the shackle leg, according to one embodiment.

FIG. 14 illustrates a schematic perspective view of housing that hosts the motor, gear box, electronic circuit, and the battery with one of the sides removed to expose the internal components, according to one embodiment.

FIG. 15 illustrates example operations that may be performed for sharing a bicycle, according to one embodiment.

### DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs.

As used herein, the term “base station” includes any wireless communication station and/or device, typically installed at a fixed terrestrial location and used to facilitate communication in a wireless communications system. For example, a base station may comprise a wireless local area network (WLAN) access point, eNode B, Node B, or the like.

As used herein, the term “mobile device” refers to a device that may from time to time have a position location that changes. For example, a mobile device may comprise a cellular telephone, wireless communication device, user equipment, laptop computer, a personal communication system (PCS) device, personal digital assistant (PDA), personal audio device (PAD), portable navigational device, and/or other portable communication devices.

Certain embodiments describe an object sharing system with a minimal implementation and set up cost. In general, the objects may be any kind of moving devices and/or vehicles such as bikes (e.g., bicycles, motor bikes, etc.), mopeds, boats, cars, and the like. With the abundance of mobile devices equipped with integrated GPS tracking devices, short range radios such as Bluetooth and near field communication (NFC) interfaces, and availability of wireless data subscription on most mobile devices, the present disclosure eliminates the need to mount and integrate these components into the object sharing system. Instead, the infrastructure is shifted to the users' mobile phones and/or devices to create a much simpler system.

A portable lock according to one embodiment is capable of communicating with a mobile device. The mobile device communicates with an administration server through internet and/or data connection to gain authorization to open/close the lock. The lock includes one or more interlocking pieces that can be secured to an object. For example, the lock can be used to secure a bike to a pole. The lock may also include a U-shaped shackle and a tube. In addition, the lock includes an electric actuator, microcontroller, a short range radio module, and a battery. In one embodiment, a mobile device interacts with the lock and a remote administration server.

One embodiment creates a platform for peer-to-peer bike sharing and opens a new market for individuals and/or groups of people to rent or share objects, such as bikes. For example, college students can decide to collaboratively share their bicycles with other students while the bicycles are not in use. As an example, each user can purchase a lock and register the lock and his or her bicycle with the administration server through a web interface. The users can set a rental price on each bicycle and get compensated through an integrated payment service managed by the remote administration server when their bicycles are used by other people. Also, owners can devise a custom policy on return locations, or create virtual kiosks and stations for each bicycle or a group of bicycles. For example, mobility can get financially incentivized through a dynamic pricing system based on different parameters such as pick-up and drop-off locations, rental time, duration and the like.

FIG. 1 illustrates an exemplary bike sharing system, in accordance with one embodiment. As illustrated, the bike sharing system includes a lock 104, a mobile device 108 and a remote administration server 112. Without loss of generality, a bicycle is shown as the protected object that is secured with the lock and is going to be shared between users. The lock 104 secures the bicycle 100 to a fixed object such as a post or a rack 102. Mobile device 108 is equipped with an embedded location tracking device (e.g., GPS) and a short range radio communication interface (e.g., Bluetooth, NFC, or the like). The location tracking device receives signals from satellite 114 and determines location of the mobile device. A user 106 interacts with the lock, for example by pressing a button located on the lock. When the button is pressed, the lock 104 is activated. The lock communicates with the mobile device 108 using the short range radio communication interface. For example, the lock uses Bluetooth signals to communicate with the mobile device. In addition, the mobile device communicates with a wireless base station 110 to access the internet and/or a data service. A remote administration server 112 processes and responds to access requests received from the mobile device. The mobile device communicates the messages received from the server with the lock. Based on the received messages, the lock is opened/closed.

FIG. 2 illustrates an example flow chart that is employed by the lock to authenticate a mobile device, according to one embodiment. As described earlier, the lock communicates with the mobile device through short range radio communication. The mobile device acts as a key to the lock to provide access to a protected object. The lock is in sleep mode until it receives an input from a user that is associated with the mobile device. The input from the user may include one or more of depression of a button, depression of a switch, or physically touching the lock that can be detected through a capacitive touch sensor. At step 200, once the lock detects user interaction and/or user input, the electronics and the radio inside the lock wakes up from deep power saving sleep mode. The radio starts broadcasting availability messages over the short range radio interface.

At step 202, the lock generates a unique session challenge number. The challenge number can be generated using any technique. As an example, a true random number generator generates a random number that can be used as the challenge number. At step 204, the lock attempts to establish a radio connection to a mobile device in its vicinity. According to one embodiment, if the lock is unable to establish a connection with the mobile device within a pre-specified period of time (step 205), the session expires and the lock refuses to accept any response. After the session is expired, the lock goes back into deep sleep mode to conserve battery energy.

Once the radio connection is established with a mobile device, at step 206, the lock transmits the generated session challenge number along with the lock unique identification number to the mobile device. The lock then waits for a response from the mobile device. If the lock does not receive a valid response from the mobile device within the pre-specified time frame (at 210), the session expires by refusing to accept any further response.

If the received response from the mobile device is valid (at 212), the lock accepts “lock” or “unlock” commands from the mobile device for a predefined time duration as long as the connection is maintained (step 214). It should be noted the lock may use any other method to authenticate a mobile device, and the steps presented in FIGS. 2 and 3 are merely examples regarding the authentication.

FIG. 3 illustrates an exemplary logic flow chart employed by a mobile device to interact with the lock, according to one embodiment. As illustrated, at 300, the mobile device scans for nearby locks. At 302, the mobile device establishes a wireless connection through short range radio interface with the nearest available lock. Alternatively, the mobile device establishes the connection with a nearby lock selected by the user through a user interface of the mobile device. At 304, the mobile device receives the session challenge number and/or the lock unique identification number (e.g., secret key) from the lock.

At 306, the mobile device checks its local memory and/or cache to determine if the secret key of the lock is locally stored on the mobile device. If yes, the mobile device is authorized to provide input to the lock (e.g., with the unique identification number). At 308, the mobile device generates a response based on secret key of the lock if the secret key is found in the local memory of the mobile device. At 312, if a cached secret key is not found, the mobile device sends a message to the administration server over the internet and/or through data service. In one embodiment, the message includes the session challenge, the lock serial number, and one or more user parameters such as user's location obtained from the phone's GPS tracking device, and the like.

The remote administration server upon the receipt of the message from the mobile device, check a database to determine whether the user is authorized to perform the requested lock/unlock action. In one embodiment, a user may be authorized to perform lock/unlock operations on the lock at specific locations and during specific time frames based on the bicycle's availability and/or permissions set by the owner. If the user is authorized to perform the requested actions, then the lock's secret key is retrieved from the database and a response is generated at the remote server. At 314, the mobile device receives the response from the remote server. At 310, the mobile device sends the response (e.g., either the response generated by the mobile device or the response received from the server) to the lock over the short range radio interface.

FIG. 4 illustrates a perspective view of an exemplary lock, according to one embodiment. The lock includes a shackle 480 and a tube housing 432. The shackle has two ends (e.g., 481 and 482). The tube housing 432 has two side openings (e.g., 470 and 471), in which the two ends of the shackle 480 are secured. In one embodiment, the tube has two openings at each of its ends that receive the end caps 400/or 446. Alternatively, only one end of the tube can be open which receives an end cap.

Both the shackle 480 and the tube 432 are made from strong substances to provide high resistance to any attempt to cut through the lock with a cutting device such as a bolt cutter, a hacksaw and the like. In this example, the shackle is U-shaped, however, in general, the shackle in the lock can have any form (e.g., D-shaped or even a non-uniform shape such as a set of interlocked chains) without departing from the teachings of the present disclosure. The shackle 480 has a pair of parallel legs 481 and 482 of substantially the same length. The leg 481 terminates in a bent end 438 which is curved outwardly. The leg 482 is straight and terminates in a cutaway section 444 with an inwardly facing boss 442 in the middle of the cutaway section.

In one embodiment, the boss 442 is a cylindrical protuberance that allows free rotational movement of the cam 402, as illustrated in FIG. 13, around its periphery. In one embodiment, apex of the boss does not project sideways beyond the perimeter or periphery of the leg. The cutaway section 444 also includes a shoulder 474 directly above the boss 442. As mentioned earlier, the tube 432 has a pair of aligned holes 470 and 471 on its sides. Distance between holes 470 and 471 correspond to the distance between the legs of the shackle 180.

FIG. 5 is a schematic exploded perspective view of the lock, according to one embodiment. As illustrated, the lock includes three operating parts: a cam 402, a motor 410, and a gear box 408. Cam 402 is best described with reference to FIG. 9 and FIG. 10. Cam 402 fits snugly inside the tube 432 (as illustrated in FIG. 4), Cam 402 is attached to the shaft 405, which is driven by the gear box 408. The gear box is also driven by the motor 410 that provides rotational movements to perform the lock and unlock operations. The gear box 408 is used to increase effective torque of the motor. When the lock command is issued by the motor controller circuitry 412, motor rotates the cam to hold the shackle. Similarly, when unlock command is issued by the motor controller circuitry 412, motor rotates the cam to release the shackle. The gear box 408 and motor 410, along with the battery 417 and the motor control circuitry 412 are all enclosed inside water-proof housing 500, as shown in FIG. 8.

FIG. 6B illustrates an exemplary sectional view of the lock sectioned at the line shown in FIG. 6A when the components are assembled inside the tube and the cam is in the unlocked position, according to one embodiment. Once the shackle is in place, the ends of shackle legs prevent access to the internal elements of the lock. To further block access to the cam and prevent picking from outside in efforts to compromise the lock security, a thick flat metal barrier 401 is pressed inside tube to sit in between the end cap 400 and the shackle leg 482.

Two plugs 446 and 400 fit at both ends of the tube 432 as illustrated in FIG. 4. The plug 446 has a slot in the middle that grips the bend end of the shackle 438 when the shackle is placed inside the opening 470 to tighten its vertical position inside the tube and prevent from horizontal movements that often creates a rattling noise.

FIG. 7B is a schematic sectional view of the lock sectioned at the line shown in FIG. 7A when the components are assembled inside the tube and the cam is in the locked position, according to one embodiment. This figure shows similar elements as FIG. 6B. The only difference is that the lock is in the locked position.

Referring back to FIG. 5, a battery 417 generates power for the movement of the lock and operation of the lock circuitry 412. In one embodiment, battery 417 has lithium thionyl chloride chemical composition with a very low self-discharge while the lock is not in use. As a result, the battery inside the lock can last for a long time without a need for replacement.

In one embodiment, the lock mechanism allows a user to replace the battery, if needed. The metal contact 418 on the cap 420 establishes an electrical connection between a terminal of the battery 417 and the spring loaded contact 416 on the motor controller circuit board 412 once the cap is screwed on the housing 500, as illustrated in FIG. 14.

FIG. 8 is a schematic view of a housing 500 that hosts the motor, gearbox, motor circuit controller, and the battery. As illustrated, housing 500 includes two portions, e.g., a left part 428 and right part 430. The housing 500 holds the motor tightly and prevents the motor from any rotational movement. In one embodiment, the housing fits snugly inside the tube 432 in between the openings 470 and 471.

FIG. 9 and FIG. 10 illustrate schematic perspective view of the back side and front side of the cam 402, respectively, according to one embodiment. As illustrated, cam 402 is a tubular solid piece and is formed with an axial opening 610 and a protuberance 612 on the side opposing the motor. When cam 402 is in the locked position, the protuberance 612 fits above the boss 442 and below the shoulder 474 of the shackle cutaway section 444 as shown in FIG. 13. In one embodiment, an inward arch 608 in the middle of the protuberance 612 creates a stable and secure locked position which eliminates translation of external pull forces on the shackle into rotational vector components on the cam that may cause the cam to rotate.

Hole 600 on the periphery of cam 402, as illustrated in FIG. 10, accommodates a retaining screw for securing the cam to the motor shaft. A depressed notch 602 as illustrated in FIG. 9 is carved on to the side of the cam facing the motor. The shoulder created by the notch 602 engages with the protuberance 429 projected outwardly from the housing half 428 to arrest the rotation of the cam in its locked and unlocked positions, as illustrated in FIG. 11 and FIG. 12.

FIGS. 11 and 12 illustrate schematic perspective views of the housing 500 and the cam in the locked and unlocked positions, respectively, according to one embodiment. When the lock is in the locked position, the cam prevents the shackle from being removed. In this case, the cam is engaged with the cut away section at the end of the shackle leg (as illustrated in FIG. 13) On the other hand, when in unlock position (FIG. 12), the cam does not engage with the shackle.

FIG. 13 is a schematic perspective view of the cam in the locked position, according to one embodiment. As illustrated, the cam 402 is engaged with the cut away section 442 at the end of the shackle leg.

FIG. 14 is a schematic perspective view of housing that hosts the motor, gear box, electronic circuit, and the battery, according to one embodiment. It should be noted that in this figure one of the sides (e.g., 428) is removed to expose the internal components. As illustrated, motor controller circuitry 412 includes a short range radio transceiver (e.g., Bluetooth, NFC, etc.), a processing unit, a motor driver 414, one or more input buttons 416, 415 and LED indicators 411, and the like. It should be noted that, in this example, both the short range radio transceiver and the processing unit is included in block 413. Buttons 416 and 415 on the motor controller circuitry 412 accept input from the user. When the lock is at rest, all of the electronic components are set into deep sleep power saving mode. Power manager of the system wakes the radio up as soon as any input is detected from the user. Indicator LEDs 411 display status of the lock. In one embodiment, the LEDs show different states of operation of the lock, such as locked, unlocked, awaiting connection, connection established, and the like.

In one embodiment, solid pegs 422 and 424 sit on the top of buttons 416 and 415 and a translucent peg 426 sits on LEDs 411, respectively. Referring back to FIG. 5, solid pegs 422, 424, 426 go through the holes on the housing 500 and the holes 460, 461, 463 on the tube housing 432, respectively. The surface of these pegs are covered by a flexible watertight sleeve 448 to prevent water intrusion into the housing 500 from the cracks around the pegs. Solid pegs 422, 424 transfer the pressure from user fingertips to the buttons, while the translucent peg 426, transfers the light from the LEDs 411 to outside of the tube 432.

In one embodiment, to replace the battery, the lock is released and the shackle is removed. After that the cap 420 at the end of the water proof housing 500 can be un-screwed and removed. Removing the cap allows the battery 417 to slide out of the tube 432. In one embodiment, a rescue power connector 409 is added to the lock to provide power to the lock in case the internal battery is depleted. The rescue power connector 409, as illustrated in FIG. 14, is accessible from outside the tube (through hole 463 as illustrated in FIG. 5) to enable powering the lock externally in case of battery depletion and/or defects. By connecting an external battery or other source of power to the external recue power pins, the lock is powered and can be normally operated.

As illustrated in FIG. 14, in one embodiment, a Hall Effect sensor 407 is positioned in between the gearbox 408 and housing 500 on a circuit board 406. The Hall Effect sensor detects position of the cam through two round magnets 403 and 404 that are placed inside holes 604 and 606 (refer to FIG. 5 and FIG. 9). The magnets are positioned such that they present opposite polarities to the sensor.

In one embodiment, multiple apertures 435 are created on the tube to allow the electromagnetic radiation to pass through the tube walls. In one embodiment, surface of the tube is covered with a layer of watertight flexible plastic skin 448 to prevent water from reaching the openings on the surface of the tube and damage the electronics.

FIG. 15 illustrates example operations that may be performed for sharing a bike, according to one embodiment. At 1502, a session is initialized on a lock in response to an input from a user. The lock is adapted to enable/disable operation of the bike when engaged with the bike. For example, the lock is used to secure the bike on a fixed object such as a pole. At 1504, in response to the initialization, the system causes a mobile device associated with the user to communicate with the lock. In one embodiment, the mobile device communicates with the lock using a short-range wireless communication method. The mobile device may receive one or more parameters from the lock.

At 1506, a server is accessed via the mobile device to verify if the mobile device is authorized to operate the lock. For example, the one or more parameters that are received from the lock are transmitted to a server for authorization. The server then verifies if the mobile device is authorized to operate the lock by searching a database. If there is a match between the parameters associate with the user and the parameters associated with the lock, then the user is allowed to unlock the lock and use the secured bike. At 1508, the lock is caused to open if the mobile device is authorized to operate the lock. Therefore, the user is enabled to operate and ride the bike in accordance with a predefined agreement (e.g., rental agreement and the like). According to one embodiment, the lock is deactivated if the session takes longer than a predefined time duration.

Various embodiments of the present invention can be implemented in the form of logic in software or hardware or a combination of both. The logic may be stored in a computer readable or machine-readable non-transitory storage medium as a set of instructions adapted to direct a processor of a computer system to perform a set of steps disclosed in embodiments of the present invention. The logic may form part of a computer program product adapted to direct an information-processing device to perform a set of steps disclosed in embodiments of the present invention. Based on the disclosure and teachings provided herein, a person of ordinary skill in the art will appreciate other ways and/or methods to implement the present invention.

The data structures and code described herein may be partially or fully stored on a computer-readable storage medium and/or a hardware module and/or hardware apparatus. A computer-readable storage medium includes, but is not limited to, volatile memory, non-volatile memory, magnetic and optical storage devices such as disk drives, magnetic tape, CDs (compact discs), DVDs (digital versatile discs or digital video discs), or other media, now known or later developed, that are capable of storing code and/or data. Hardware modules or apparatuses described herein include, but are not limited to, application-specific integrated circuits (ASICs), field-programmable gate arrays (FPGAs), dedicated or shared processors, and/or other hardware modules or apparatuses now known or later developed.

The methods and processes described herein may be partially or fully embodied as code and/or data stored in a computer-readable storage medium or device, so that when a computer system reads and executes the code and/or data, the computer system performs the associated methods and processes. The methods and processes may also be partially or fully embodied in hardware modules or apparatuses, so that when the hardware modules or apparatuses are activated, they perform the associated methods and processes. The methods and processes disclosed herein may be embodied using a combination of code, data, and hardware modules or apparatuses.

The above descriptions of embodiments of the present invention are illustrative and not limitative. Other modifications and variations will be apparent to those skilled in the art and are intended to full within the scope of the appended claims. For example, the shackle, cam, and the housings could have any shapes without departing from the teachings of the present disclosure.

What is claimed is:

1. A lock comprising:
a shackle having first and second ends;
a first housing having first and second side openings configured to receive the first and second ends, respectively;
a second housing housed within the first housing, the second housing comprising:
a battery recess configured to receive a battery;
a motor assembly positioned within a motor assembly recess of the second housing, the motor assembly including a rotatable shaft drivable by a motor of the motor assembly;
a locking cam coupled to the rotatable shaft and including a first protuberance, the locking cam rotatable between a locked position where the first protuberance locks the first end within the first opening and an unlocked position where the first protuberance unlocks the first end within the first opening; and
motor control circuitry communicatively coupled to the motor; and
a sensor positioned adjacent to the locking cam and communicatively coupled to the motor control circuitry.

2. The lock of claim 1, wherein the second housing further includes a removable, conductive battery cover, the battery cover electrically coupling the battery and the motor control circuitry when the recess cover is removably attached to the second housing.

3. The lock of claim 1, wherein the sensor is a Hall effect sensor.

4. The lock of claim 1, wherein the motor control circuitry includes a transceiver and a push button.

5. The lock of claim 1, wherein the first housing further comprises one or more end openings configured to receive one or more end caps.

6. The lock of claim 1, further comprising a press-fit disc disposed within the first housing and between the locking cam and an end opening of the first housing.

7. The lock of claim 1, wherein the first end of the shackle includes a boss and the second end of the shackle is bent.

8. The lock of claim 1, wherein the second housing further includes a second protuberance positioned on an exterior surface of the second housing and configured to limit a range of rotation of the locking cam when the shaft is driven by the motor and a notch of the locking cam contacts the second protuberance.

9. The lock of claim 1, wherein the second housing is positioned between the first and the second side openings of the first housing.

10. A lock comprising:
a shackle having first and second ends;
a first housing having first and second side openings configured to receive the first and second ends, respectively;
a second housing housed within the first housing, the second housing comprising:
a battery;
a motor assembly including a rotatable shaft drivable by a motor of the motor assembly;
a locking cam coupled to the rotatable shaft and including a first protuberance, the locking cam rotatable between a locked position where the first protuberance locks the first end within the first opening and an unlocked position where the first protuberance unlocks the first end within the first opening; and
motor control circuitry communicatively coupled to the motor and including at least one of a transceiver and a push button, the push button accessible via first and second button holes in the first and second housings, respectively; and
a sensor positioned adjacent to the locking cam, communicatively coupled to the motor control circuitry and configured to determine whether the locking cam is in the locked position or the unlocked position,
wherein upon receiving a user input at the motor control circuitry, the motor control circuitry instructs the motor to rotate the locking cam via the shaft to the locked position when the sensor determines that the locking cam is in the unlocked position or to the unlocked position when the sensor determines that the locking cam is in the locked position.

11. The lock of claim 10, wherein the user input corresponds to at least one of a wireless communication received by the transceiver and a depression of the push button.

12. The lock of claim 10, wherein the motor includes a gearbox.

13. The lock of claim 10, wherein the motor control circuitry includes a microprocessor.

14. The lock of claim 10, wherein the transceiver is configured to exit a power sleep mode upon receiving an input.

15. The lock of claim 15, wherein the input corresponds to at least one of a depression of the push button and physically touching the lock.

16. A method of sharing a bike, comprising:
initializing a session on a lock in response to an input from a user, said lock adapted to enable/disable operation of the bike when engaged with the bike;
causing a mobile device associated with the user to communicate with the lock in response to the initialization;
accessing a server via the mobile device to verify if the mobile device is authorized to operate said lock; and
causing the lock to open if the mobile device is authorized to operate said lock, thereby enabling the user to operate and ride the bike in accordance with a predefined agreement.

17. The method of claim 16, wherein the mobile device communicates with the lock using a short-range wireless communication method.

18. The method of claim 16, wherein causing the mobile device to communicate with the lock comprises causing the mobile device to receive one or more parameters from the lock.

19. The method of claim 18, wherein accessing the server to verify if the mobile device is authorized to operate said lock comprises:
causing the mobile device to transmit the one or more parameters to the server; and
causing the server to verify if the mobile device is authorized to operate said lock based at least on the one or more parameters.

20. The method of claim 16, further comprising:
deactivating the lock if the session takes longer than a predefined time duration.
